(19) United States
(12) Patent Application Publication
(10) Pub. No.: US 2019/0100091 A1
(43) Pub. Date: Apr. 4, 2019

(54) Automobile Hybrid Power Generator System Including Double-Acting Power Generation Unit

(71) Applicant: JIYOUNGLINSYSTEM CO., LTD., Incheon (KR)

(72) Inventor: Kwang Young YOO, Incheon (KR)

(21) Appl. No.: 16/083,369

(22) PCT Filed: Mar. 3, 2017
(86) PCT No.: PCT/KR2017/002318

§ 371 Date: Sep. 7, 2018

(30) Foreign Application Priority Data
Mar. 10, 2016 (KR) 10-2016-0028618

(51) Int. Cl. B60K 6/28; B60K 6/24; B60K 6/26; B60K 6/38; B60K 6/42; B60W 20/10; F16H 55/36

(52) U.S. Cl. CPC B60K 6/28; B60K 6/24; B60K 6/26; F16H 55/36; B60K 6/42; B60W 20/10; B60K 6/38

(57) ABSTRACT

The present invention relates to an automobile hybrid power generator system including a double-acting power generation unit and, more specifically, to an automobile hybrid power generator system including a double-acting power generation unit which not only allows the double-acting power generation unit to store mechanical power of an engine as electrical energy and supply electrical energy required to drive an automobile, but also, as the occasion demands, allows the double-acting power generation unit to assist power of the engine due to the characteristics of the double-acting power generation unit, and thus increases the fuel consumption efficiency of the automobile and improves the fuel efficiency thereof.

### FIELD OF THE INVENTION

The present invention relates to a hybrid generator system for a vehicle equipped with a double-acting generator, and more particularly, to a hybrid generator system for a vehicle equipped with a double-acting generator, which stores mechanical power of an engine as electrical energy, supplies the electrical energy required for operation of a vehicle and, at the same time, assists the power of the engine as needed, thereby increasing the fuel efficiency and reducing the fuel consumption.

### DESCRIPTION OF RELATED ART

In order to use various electrical and electronic components provided in a vehicle, including starting the vehicle, it is necessary to continuously charge a battery, which is made by a generator.

Although the generator is located in front of an engine room, it is difficult to identify the generator with the naked eye, but it is always connected to a crankshaft and a pulley of the engine to constantly charge the battery.

Therefore, converting the mechanical energy of the engine into electrical energy without loss and storing the converted electrical energy in the battery results in an increase in fuel efficiency and a reduction in fuel consumption.

On the contrary, conventional vehicles have structural limitations for achieving the above-described effects, and thus hybrid vehicles have been developed to overcome these limitations.

A hybrid vehicle is operated by an internal combustion engine and an electric motor and is a next generation vehicle that is designed to significantly reduce fuel consumption and harmful gas emissions, compared to conventional vehicles.

However, the hybrid vehicle is defined as a system that drives the wheels by the engine and the electric motor, and thus it is necessary to change the structure of the vehicle. Moreover, it is equipped with a high-capacity battery, which increases the weight of the vehicle and also increases the economic cost, placing the burden on consumers to select and use it.

Accordingly, the present invention is aimed at achieving the effects of hybrid vehicles by providing a more reliable and stable electrical system in a vehicle with a simple configuration by focusing on the driving of a generator of the vehicle so as to obtain the same effects of fuel efficiency improvement and fuel consumption reduction as the hybrid vehicles and so as to be easily applied to conventional vehicles, departing from the concept of the existing hybrid vehicle system that drives the wheels using the engine and the electric motor.

As a prior art that relates to a hybrid generator system for a vehicle, Korean Patent No.: 10-0471852, entitled “Battery Charge System for Vehicle” (hereinafter refer to as “prior art 1”) discloses a battery charging system for a vehicle comprising: first and second detecting sensors for detecting a voltage of a battery and an engine driving state, respectively, and outputting them as electrical signals; a control unit for determining whether to charge the battery based on the signals input from the first and second detecting sensors; a motor driven by an electric current applied by a control signal of the control unit; a power transmission means for transmitting the driving force of the motor to an alternator; and a power connection means for disconnecting the connection between the engine and the alternator during driving of the motor and maintaining the connection during normal state, wherein when the voltage of the battery is below a reference value and does not allow the engine to operate, the alternator is forcibly driven to automatically change the battery.

However, although prior art 1 can prevent the battery from being discharged, a separate motor for forcibly driving the alternator is required for this purpose, and electrical energy is further required to drive the motor, which causes an overload in the electrical system of the vehicle, thereby making the electrical system of the vehicle unstable and, at the same time, increasing the fuel consumption of the vehicle.

### SUMMARY OF THE INVENTION

Accordingly, the present invention has been made in an effort to solve the above-mentioned problems, and an object of the present invention is to provide a hybrid generator system for a vehicle equipped with a double-acting generator, which is substituted for a generator provided in a conventional vehicle such that an electronic control unit controls a plurality of generators and batteries provided in the double-acting generator to store mechanical power of an engine as electrical energy and assist the power of the engine with the stored energy as needed so as to cope with various situations during operation of the vehicle, thereby increasing the fuel efficiency and reducing the fuel consumption.

Another object of the present invention is to provide a hybrid generator system for a vehicle equipped with a double-acting generator in which, even when mechanical energy of an engine is not supplied, energy exchange and charge between a plurality of generators and batteries provided in the double-acting generator can be achieved by operation of an electromagnetic clutch, and thus the power of the engine for starting the generators is not required, thereby increasing the energy efficiency of the engine.

In addition, still another object of the present invention is to provide a hybrid generator system for a vehicle equipped with a double-acting generator, which has a simple configuration and thus can be easily applied to a conventional vehicle, thereby achieving the effects, which can be obtained from expensive hybrid vehicles, at relatively low cost.

In order to achieve the above objects, the present invention provides a hybrid generator system for a vehicle equipped with a double-acting generator, comprising: an engine for generating mechanical power of a vehicle by fuel combustion; a double-acting generator for storing and outputting the power of the engine as electrical energy; a pulley for transmitting the power of the engine to the double-acting generator; and an electronic control unit for controlling the entire system of the vehicle, wherein an electromagnetic clutch, which is switched between OPEN-CLOSE states by electrical signals of the electronic control unit, is provided between the double-acting generator and the pulley so as to effectively use the double-acting generator, thereby increasing the fuel efficiency of the vehicle.

Here, the double-acting generator comprises: a first generator for converting the mechanical energy of the engine into electrical energy and, at the same time, acting as a motor for generating a rotational force by an electrical signal of the electronic control unit; a first storage battery for storing the electrical energy generated by the first generator; a second generator for converting the mechanical energy of the engine and, at the same time, acting as a motor for generating a rotational force by an electrical signal of the electronic control unit in the same manner as the first generator; and a second storage battery for storing the electrical energy generated by the second generator, wherein the second generator is connected in series with the first generator on the same axis as the first generator to also receive the power transmitted from the engine to the first generator.

Prior to this, the terms or words used in the specification and claims of the present application should not be construed as being limited to ordinary or dictionary meanings, but should be construed as meanings and concepts conforming to the technical spirit of the present invention on the basis of the principle that the inventor can define the concept of the terms properly to explain his invention in the best way.

Accordingly, it should be understood that embodiments described in the specification and the configurations shown in the drawings are just the most preferred embodiments of the present invention and do not fully cover the spirit of the present invention, and thus there may be various equivalents and modifications that can replace these embodiments at the time of filing this application.

### Advantageous Effects

As described above, according to the present invention, with the use of the double-acting generator substituted for a generator provided in a conventional vehicle, it is possible to store the mechanical energy of the engine and assist the power of the engine with the stored energy as needed depending on various situations during operation of the vehicle, thereby increasing the fuel efficiency and reducing the fuel consumption.

Moreover, even when the mechanical energy of the engine is not supplied, energy exchange and charge between the plurality of generators and batteries provided in the double-acting generator can be achieved by the operation of the electromagnetic clutch, and thus the power of the engine for operating the generators is not required, thereby increasing the energy efficiency of the engine. Moreover, the double-acting generator of the present invention has a simple configuration and thus can be easily applied to a conventional vehicle, thereby achieving the effects, which can be obtained from expensive hybrid vehicles, at relatively low cost.

In addition, the present invention is effective in ensuring safety during operation of the vehicle by preventing battery discharge by the use of the plurality of generators and batteries, thereby constructing a stable electrical system of the vehicle.

Furthermore, while the conventional hybrid vehicles are applied to limited types of vehicles, the present invention can be applied to all types of vehicles, and particularly, it can also be easily applied to a large vehicle so as to reduce the fuel consumption.

### BRIEF DESCRIPTION OF THE DRAWINGS

FIG. 1 is a schematic view of a hybrid generator system for a vehicle equipped with equipped with a double-acting generator according to the present invention.

FIG. 2 is a block diagram of a hybrid generator system for a vehicle equipped with a double-acting generator according to the present invention.

FIG. 3 is a detailed view of a double-acting generator in a hybrid generator system for a vehicle equipped with a double-acting generator according to the present invention.

FIG. 4 shows examples of operations for each scenario of a hybrid generator system for a vehicle equipped with a double-acting generator according to the present invention.

FIG. 5 is a representative view of a prior art hybrid generator system for a vehicle equipped with a double-acting generator according to the present invention.

### DETAILED DESCRIPTION OF THE PREFERRED EMBODIMENTS

Hereinafter, the configuration and operation of a hybrid generator system for a vehicle equipped with a double-acting generator according to the present invention will be described in detail with reference to the accompanying drawings.

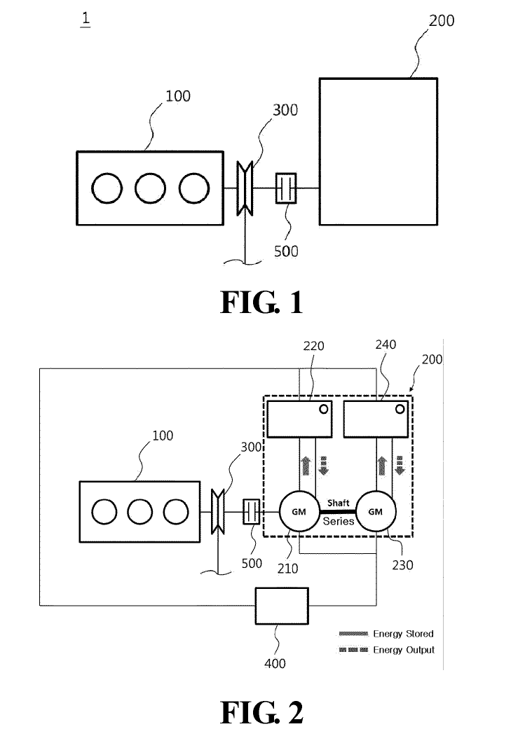

FIG. 1 is a schematic view of a hybrid generator system for a vehicle equipped with equipped with a double-acting generator according to the present invention, and FIG. 2 is a configuration diagram of a hybrid generator system for a vehicle equipped with a double-acting generator according to the present invention.

As shown in FIGS. 1 and 2, the present invention is directed to a hybrid generator system 1 for a vehicle equipped with a double-acting generator, comprising: an engine 100 for generating mechanical power of a vehicle by fuel combustion; a double-acting generator 200 for storing and outputting the power of the engine 100 as electrical energy; a pulley 300 for transmitting the power of the engine 100 to the double-acting generator 200; and an electronic control unit 400 for controlling the entire system of the vehicle, wherein an electromagnetic clutch 500, which is switched between OPEN-CLOSE states by electrical signals of the electronic control unit 400, is provided between the double-acting generator 200 and the pulley 300 so as to effectively use the double-acting generator 200, thereby increasing the fuel efficiency of the vehicle.

The mechanical energy of the engine 100 generated by fuel combustion is transmitted to the double-acting generator 200 by the pulley 300, and this mechanical energy transmitted to the double-acting generator 200 is converted into electrical energy and stored in the double-acting generator 200 in the same manner as the conventional generator.

As mentioned above, the electromagnetic clutch 500 located between the pulley 300 and the double-acting generator 200 is switched between an OPEN state where the connection with the engine 100 is blocked by an electrical signal of the electronic control unit 400 and a CLOSE state where the connection with the engine 100 is made by an electrical signal of the electronic control unit 400 to store or output the electrical energy.

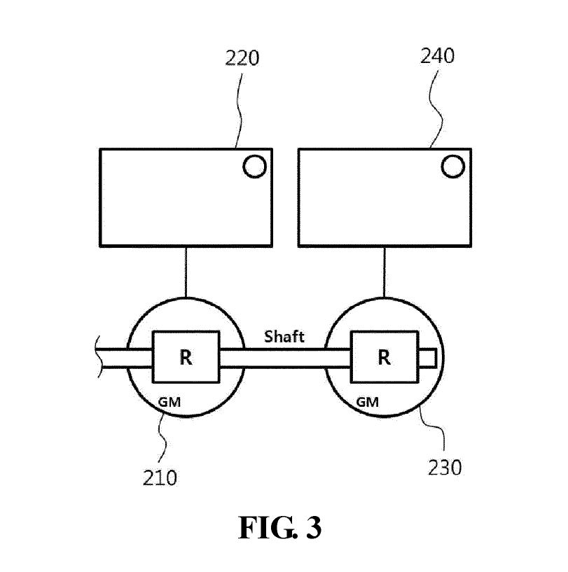

As shown in FIGS. 2 and 3, the double-acting generator 200 comprises: a first generator 210 for converting the mechanical energy of the engine 100 into electrical energy and, at the same time, acting as a motor for generating a rotational force by an electrical signal of the electronic control unit 400; a first storage battery 220 for storing the electrical energy generated by the first generator 210; a second generator 230 for converting the mechanical energy of the engine 100 and, at the same time, acting as a motor for generating a rotational force by an electrical signal of the electronic control unit 400 in the same manner as the first generator 210; and a second storage battery 240 for storing the electrical energy generated by the second generator 230.

Moreover, as shown in FIGS. 2 and 3, the second generator 230 is connected in series with the first generator 210 on the same axis as the first generator 210 to also receive the power transmitted from the engine 100 to the first generator 210.

Therefore, when the electromagnetic clutch 500 is switched to the CLOSE state by the electronic control unit 400, the second generator 230 can also receive the mechanical energy of the engine 100, convert the mechanical energy into electrical energy, and store the converted electrical energy in the second storage battery 240 in the same manner as the first generator 210.

That is, the present invention is configured to allow the second generator 230 to convert the mechanical energy of the engine 100 into electrical energy and store the converted electrical energy in the second storage battery 240 in the same manner as the first generator 210, which converts the mechanical energy varying depending on the output of the engine 100 into electrical energy and stores the converted electrical energy into the first storage battery 220, such that a plurality of generators can be operated by the mechanical energy generated by the engine 100 for operating a single generator and the energy can be stored in each of a plurality of batteries.

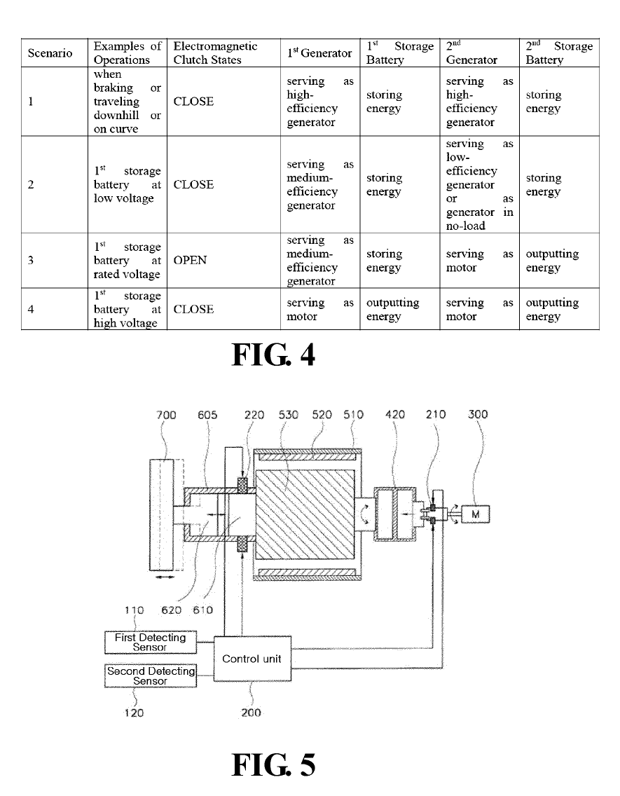

The functions and roles of the first generator 210, the first storage battery 220, the second generator 230, and the second storage battery 240 are systematically changed depending on the OPEN-CLOSE states of the electromagnetic clutch 500 operated by electrical signals of the electronic control unit 400 as shown in the examples of operations for each scenario of FIG. 4.

For example, according to the present invention, in scenario 1, when the vehicle is braking or traveling downhill or on a curve, the electromagnetic clutch 500 is switched to the CLOSE state, and at this time, the first generator 210 and the second generator 230 act as high-efficiency generators to convert the mechanical energy of the engine 100 into electrical energy and store the converted electrical energy in the first storage battery 220 and the second storage battery 240, respectively.

This is because the intensity of the power of the engine 100 is equal to the power of the generator, and the power of the generator is equal to the intensity of the current supplied to the battery as well as the charging rate of the battery and is proportional to the braking force.

Therefore, the first and second generators 210 and 230 operate as high-efficiency generators by electrical signals of the electronic control unit 400.

In scenario 2, when the first storage battery 220 is at a low voltage due to consumption of electrical energy of the vehicle, the electromagnetic clutch 500 is switched to the CLOSE state for storing the electrical energy, and the first storage battery 220 receives the mechanical energy of the engine 100, converts the mechanical energy into electrical energy, and stores the converted electrical energy.

At this time, the second generator 230 also operates as a generator for storing electrical energy and acts as an auxiliary generator for low efficiency power generation or as a generator in no-load state which is not affected by the mechanical energy of the engine 100.

In scenario 3, when the first storage battery 220 is at its rated voltage due to the mechanical energy transmitted from the engine 100, it is no longer necessary to receive the mechanical energy from the engine 100, and thus the first storage battery 220 acts as a main generator to supply electrical energy required for the operation of the vehicle. At this time, the secondary generator 230 as an auxiliary generator acts as a motor to output the electrical energy stored in the second storage battery 240 so as to prevent the voltage from dropping within the rated voltage, thereby supplying mechanical energy as a motor, instead of the mechanical energy of the engine 100 to be supplied to the first generator 210.

In scenario 4, when the first storage voltage 220 is at a high voltage, the electrical energy stored in the first storage battery 220 and the second storage battery 240 by electrical signals of the electronic control unit 400 is output to allow the first generator 210 and the second generator 230 to serve as motors, respectively, such that the first and second generators 210 and 230 supply mechanical energy to assist the mechanical energy of the engine 100 in the CLOSE state of the electromagnetic clutch 500, thereby reducing the fuel consumption required for generating the power of the engine 100.

That is, as described above, the first and second generators 210 and 230 assist the power of the engine 100 so as to provide periodic breaks to the engine 100 or to prevent the engine 100, which generates power by fuel combustion, from being overloaded, depending on the operations of the electromagnetic clutch 500 for each scenario by the electronic control unit 400, thereby increasing the fuel efficiency and reducing the fuel consumption.

The first and second generators 210 and 230 shown in FIG. 4 are at high efficiency when the fuel consumption of the engine 100 is high, at low efficiency when the fuel consumption is low, and at medium efficiency when the fuel consumption is normal.

Moreover, as shown in FIG. 4, the first and second storage batteries 220 and 240 have a rated voltage of 12 V and should maintain a voltage of 13 V to 15 V.

It should be noted that the electronic control unit 400 is configured to further control the electromagnetic clutch 500 and the double-acting generator 200 based on an electronic control unit (ECU) system applied to the existing vehicle, and the first generator 210 and the second generator 230 are defined as “major generator” and “auxiliary generator” to facilitate understanding of the present invention, but these terms are used to distinguish the first generator 210 and the second generator 230, and the “main generator” and the “auxiliary generator” have the same function and role.

In summary, the present invention limits the operation of the generators provided in the vehicle by the electromagnetic clutch 500 to thereby increase the fuel efficiency of the engine 100 and reduce the fuel consumption. Moreover, the double-acting generator 200 can be substituted for the generators and batteries provided in the existing vehicle and thus can be easily applied to existing vehicles.

That is, the electrical energy stored in the first storage battery 220 is mainly supplied by the power of the engine 100, and in a normal state, the connection between the engine 100 and the double-acting generator 200 is blocked, and the second generator 230 is operated as a motor to supply mechanical energy to the first generator 210, instead of the power of the engine 100, such that electrical energy can be stored in the first storage battery 220.

Therefore, the core of the present invention is to block the connection between the engine 100 and the double-acting generator 200 as much as possible, thereby reducing the fuel consumption of the engine 100.

The terms “power” and “mechanical energy” used together are of the same energy type and generated from the engine 100.

It will be apparent to those skilled in the art that the present invention is not limited to the embodiments described in the specification, but various modifications and variations can be made without departing from the spirit or scope of the invention.

Accordingly, the present invention may be embodied in other specific forms without departing from the technical idea or essential features thereof, and thus the embodiments of the present invention are only illustrative and should not be interpreted as limiting the present invention.

A generator provided in a vehicle together with an engine, which is an internal combustion engine of the vehicle, is configured to store electrical energy required for the vehicle in a battery and, at the same time, to allow the engine to be continuously used at an increased output due to its continuous operation.

Therefore, the hybrid generator system for a vehicle equipped with the double-acting generator according to the present invention comprises a plurality of generators to which the mechanical energy of the engine in the existing vehicle is transmitted so as to allow electrical energy to be stored in each of a plurality of corresponding batteries. As a result, it is possible to reduce the fuel consumption by blocking the connection with the engine to reduce the output of the engine as needed, and as energy exchange and charge between the plurality of generators and batteries can be achieved when the connection with the engine is blocked, it is possible to supply electrical energy required for the vehicle. Therefore, the hybrid generator system of the present invention can contribute to promotion of various automobile industrial fields such as existing automobile industry, hybrid automobile industry, etc.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1) A hybrid generator system for a vehicle equipped with a double-acting generator, comprising: an engine for generating mechanical power of a vehicle by fuel combustion; a double-acting generator for storing and outputting the power of the engine as electrical energy; a pulley for transmitting the power of the engine to the double-acting generator; and an electronic control unit for controlling the entire system of the vehicle, wherein the operation of the double-acting generator can be maintained even when the mechanical energy is not supplied from the engine, wherein the double-acting generator comprises: a first generator for converting the mechanical energy of the engine into electrical energy and, at the same time, acting as a motor for generating a rotational force by an electrical signal of the electronic control unit; a first storage battery for storing the electrical energy generated by the first generator; a second generator for converting the mechanical energy of the engine and, at the same time, acting as a motor for generating a rotational force by an electrical signal of the electronic control unit in the same manner as the first generator; and a second storage battery for storing the electrical energy generated by the second generator, wherein an electromagnetic clutch, which is switched between OPEN-CLOSE states by electrical signals of the electronic control unit, is provided between the double-acting generator and the pulley to allow the double-acting generator to receive the mechanical energy from the engine when the double-acting generator is connected to the engine by the electromagnetic clutch or to allow the double-acting generator to generate electrical energy when the connection with the engine is blocked so as to provide periodic breaks to the engine by an interaction of energy due to a systematic relationship between the first and second generators and the first and second storage batteries, thereby reducing the fuel consumption of the engine for driving the first and second generators.
